(19) United States
(12) Patent Application Publication
(10) Pub. No.: US 2024/0125920 A1
(43) Pub. Date: Apr. 18, 2024

(54) PROCESS AND DEVICE FOR GENERATING AT LEAST ONE SYNTHETIC RADIO FREQUENCY IMAGE FOR MACHINE LEARNING

(71) Applicant: Rohde & Schwarz GmbH & Co. KG, Munich (DE)

(72) Inventors: Christoph BAUR, Augsburg (DE); Georg SCHNATTINGER, Dorfen (DE); Benedikt HUBER, Munich (DE)

(73) Assignee: Rohde & Schwarz GmbH & Co. KG, Munich (DE)

(21) Appl. No.: 18/046,746

(22) Filed: Oct. 14, 2022

(51) Int. Cl. G01S 13/89; G06T 7/70; G06T 17/20; G06V 10/74

(52) U.S. Cl. CPC G01S 13/89; G06T 7/70; G06T 17/20; G06V 10/761; G06T 2207/20044; G06T 2207/20081; G06T 2207/30196

(57) ABSTRACT

Disclosed are a process (1) and a device (2) for generating at least one synthetic radio frequency, RF, image for machine learning. The process (1) comprises: having (11) a three-dimensional, 3D, body model of a human; sampling (12) the 3D body model; and generating (13) the at least one synthetic RF image in accordance with an imaging transformation of the 3D body sample. This provides labeled data in the form of RF images for training of machine learning algorithms.

### TECHNICAL FIELD

The present disclosure relates to full-body security scanning of humans, and in particular to a process and a device of generating at least one synthetic radio frequency (RF) image for associated machine learning.

### BACKGROUND ART

Full-body security scanners started supplementing metal detectors at airports and train stations in many countries to automatically detect potentially dangerous items carried on the body or in clothing, without physically removing the same or making physical contact. Typically, active scanners direct RF radiation, such as millimeter wave energy, at the subject and then interpret the reflected energy.

Since intimate details also become visible, the preservation of personal and data protection rights requires rapid image processing to filter out anomalies from the measured data for display on an avatar.

The actual goal of the full-body scanning is therefore to identify areas on the scanned body that significantly deviate from a ‘normal’ unsuspicious body shape. This is where machine learning comes to the aid of image processing. However, teaching machine learning algorithms what constitutes a body without concealed objects requires sufficient training based on high-quality data.

Conventionally, such RF imaging data for machine learning purposes is generated through manual, tedious, time-consuming and costly data collections with real human beings.

### SUMMARY

In view of the above-mentioned drawbacks and limitations, an objective is to synthesize RF images for machine learning purposes.

The objective is achieved by the embodiments as defined by the appended independent claims. Preferred embodiments are set forth in the dependent claims and in the following description and drawings.

A first aspect of the present disclosure relates to a process of generating at least one synthetic radio frequency, RF, image for machine learning. The process comprises having a three-dimensional, 3D, body model of a human; sampling the 3D body model; and generating the at least one synthetic RF image in accordance with an imaging transformation of the 3D body sample.

The at least one synthetic RF image may comprise a microwave image.

The at least one synthetic RF image may comprise a plurality of synthetic RF images.

The plurality of synthetic RF images may represent different shooting angles.

The plurality of synthetic RF images may represent different body constitutions.

The plurality of synthetic RF images may represent different body postures.

The plurality of synthetic RF images may represent different body movements.

Having the 3D body model may comprise: forming a 3D body model from a computer-aided design, CAD, based body skeleton model and a CAD-based body surface mesh model; shaping the 3D body model in accordance with given shape parameters; and mobilizing the 3D body model in accordance with given motion capture data;

Mobilizing the 3D body model may comprise: retargeting the given motion capture data onto the body skeleton model of the 3D body model; and skinning the body surface mesh model of the retargeted 3D body model in accordance with a Linear Blend Skinning, LBS, algorithm and given mobilization weights.

The imaging transformation may comprise one of: a physical optics based electromagnetic, EM, simulation, and an inference by a machine learning, ML, algorithm being trained for RF imaging of 3D body samples.

The physical optics based simulation may comprise ray-based shadowing.

The physical optics based simulation may take into account multiple transmitters and receivers.

The physical optics based simulation may use graphics processing unit, GPU, acceleration.

The process may further comprise: training a further ML algorithm in accordance with the at least one synthetic RF image for inference of a similarity with the at least one synthetic RF image.

The process may further comprise: providing an RF image to be analyzed.

Providing the RF image to be analyzed may comprise: augmenting the shaped 3D body model with a CAD-based 3D model of an object to be detected; mobilizing the augmented 3D body model in accordance with the given motion capture data; sampling the mobilized augmented 3D body model; and generating the RF image to be analyzed in accordance with the EM simulation of the augmented 3D body sample.

Providing the RF image to be analyzed may comprise: generating the RF image to be analyzed in accordance with an RF image of an object to be detected and one of the at least one synthetic RF images corresponding in terms of the shooting angle, the body constitution and/or the body posture.

The process may further comprise: inferring from the trained ML algorithm the similarity of the provided RF image to be analyzed with the at least one synthetic RF image.

The process may further comprise: inferring from the trained ML algorithm the similarity with the provided RF image to be analyzed with the at least one synthetic RF image for different simulation setups of the physical optics based simulation; and deriving a robustness of the inference against the different simulation setups.

A second aspect of the present disclosure relates to a device of generating at least one synthetic radio frequency, RF, image for machine learning. The device comprises a processor, being configured to: have a three-dimensional, 3D, body model of a human; sample the 3D body model; and generate the at least one synthetic RF image in accordance with an imaging transformation of the 3D body sample.

### Advantageous Effects

The proposed method provides potentially unlimited quantities of RF images of humans of arbitrary height, body-mass index (BMI), gender, and the like, in arbitrary poses and motions, for training of machine learning algorithms. This
strongly reduces the need for costly and time-consuming data collections, which cannot even guarantee to provide all required scenarios (although real data is still needed for validation),—
reduces or even eliminates manual labelling and data curation, since the generated data has inherent labels due to the fact it is synthetically generated,
enables highly efficient and fast-paced development of machine learning algorithms, customer-specific and customer-driven tailoring, and
reduces or eliminates personal and data privacy concerns.

The technical effects and advantages described above in relation with the method equally apply to the device having corresponding features.

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a process in accordance with the present disclosure for generating at least one synthetic radio RF image for machine learning;

FIG. 2 illustrates a device in accordance with the present disclosure for generating at least one synthetic radio RF image for machine learning; and

FIGS. 3-5 respectively illustrate details of the process of FIG. 1.

### DETAILED DESCRIPTIONS OF DRAWINGS

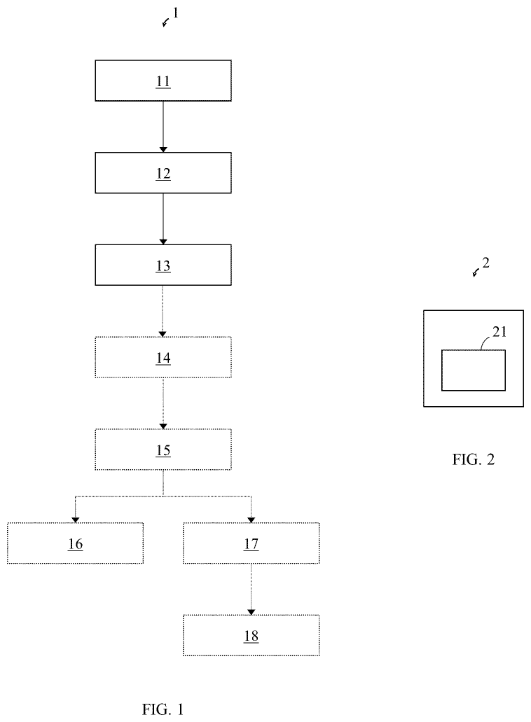

FIG. 1 illustrates a process 1 in accordance with the present disclosure for generating at least one synthetic radio RF image for machine learning.

In its most generic implementation, the process 1 comprises three steps, namely: having 11 a three-dimensional (3D) body model of a human; sampling 12 the 3D body model; and generating 13 the at least one synthetic RF image in accordance with an electromagnetic (EM) simulation of the 3D body sample. As used herein, sampling a body model may refer to making a snapshot or copy of the body model in a particular pose (e.g., at a particular time instant when animating the body model).

This provides a fully automatic and flexible algorithm for synthesizing RF images from computer graphics mesh models of human subjects in an arbitrary static pose, in an arbitrary motion, or a varying constitution/anatomy (height, gender, BMI etc.).

An EM simulation as used herein may refer to translation of a computer aided design (CAD) model of a human into the microwave domain, which allows generation of highly realistic data according to the hardware characteristics of the imaging system. The EM simulation can help to understand and model physical effects under defined conditions. But more importantly, it can also be used to solve the issue of data scarcity. Training and evaluation of ML algorithms require large quantities of exemplary data, which to date must be collected manually in time-consuming, labor-intensive and costly data collections. With the help of the proposed process, rich datasets of humans in arbitrary pose or motions can be generated for ML development fully automatically. Existing datasets can be enhanced with specific, missing scenarios easily, fast and at almost no cost.

The generated synthetic RF images have inherent labels due to the fact that they are synthetically generated. In other words, labels such as body size, body constitution (e.g., BMI), gender, etc. used to shape the underlying 3D body model of the human may form metadata provided with the synthetic RF images. This metadata may be used to label the synthetic RF images for training of ML algorithms.

The at least one synthetic RF image may comprise a microwave image.

Microwave frequencies extend from 300 MHz to 300 GHz corresponding to wavelengths between 1 m and 1 mm. The section from 30 GHz to 300 GHz with wavelengths between 10 mm and 1 mm is also called millimeter waves. In different dielectric media they propagate differently fast and at surfaces between them they are reflected. Another part propagates beyond the surface. The larger the difference in the wave impedance, the larger is the reflected part. For full-body security scanning of humans, these reflections may be represented as an RF/microwave image.

The at least one synthetic RF image may comprise a plurality of synthetic RF images.

The plurality of synthetic RF images may represent different shooting angles, different body constitutions, different body postures, and/or different body movements.

A shooting angle as used herein may refer to a perspective on the 3D body model.

A body constitution as used herein may refer to all the body-related characteristics of a human, such as being tall or short, being thick or thin, being muscled or non-muscled etc.

A body posture as used herein may refer to a position or bearing of the body whether characteristic or assumed for a special purpose.

A body movement as used herein may refer to a sequence of images of varying body posture.

The process 1 may further comprise: training 14 a further ML algorithm in accordance with the at least one synthetic RF image for inference 16 of a similarity with the at least one synthetic RF image.

For example, such a ML algorithm may include supervised learning of an artificial neural network.

A trained ML algorithm may have learned what constitutes a human body, and may thus be used for detection of body posture, detection of proper movement (e.g., through a full-body scanner), detection of threat objects, detection of similar bodies, testing of ML algorithms against edge cases (e.g. very high BMI, very tall or short people, bodybuilders, etc.) and the like.

The process 1 may further comprise: providing 15 an RF image to be analyzed.

For detection of a threat object, the RF image to be analyzed may include the threat object besides the human body.

For detection of body postures, similar bodies, or proper movement, the RF image to be analyzed may include only the human body.

The process 1 may further comprise: inferring 16 from the trained ML algorithm the similarity of the provided RF image to be analyzed with the at least one synthetic RF image.

For example, this may be used to identify areas on the human body in the provided RF image which significantly deviate from a normal unsuspicious body shape (i.e., detection of threat objects), detection of body posture, and the like.

Alternatively, the process 1 may further comprise: inferring 17 from the trained ML algorithm the similarity of the provided RF image to be analyzed with the at least one synthetic RF image for different simulation setups of the physical optics based simulation; and deriving 18 a robustness of the inference against the different simulation setups.

This may be used to test a robustness of the trained ML algorithm in accordance with different simulation setups, such as different antenna configurations.

FIG. 2 illustrates a device 2 in accordance with the present disclosure for generating at least one synthetic radio RF image for machine learning.

The device 2 comprises a processor 21, being configured to: have 11 a three-dimensional, 3D, body model of a human; sample 12 the 3D body model; and generate 13 the at least one synthetic RF image in accordance with an electromagnetic, EM, simulation of the 3D body sample.

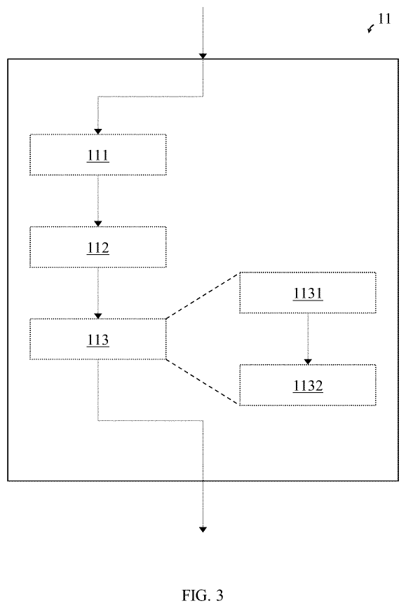

FIGS. 3-5 respectively illustrate details of the process of FIG. 1.

FIG. 3 deals with details of the step of having 11 the 3D body model, which may comprise: forming 111 a 3D body model from a CAD-based body skeleton model and a CAD-based body surface mesh model; shaping 112 the 3D body model in accordance with given shape parameters; and mobilizing 113 the 3D body model in accordance with given motion capture data.

In the forming 111 step, the human body may be modeled based on a surface mesh M, a skeleton S and some animation weights W. Thus, such a body model may be defined by a tuple m=(M, S, W).

Suitable human CAD models are available from various open-source projects, for example.

In the shaping 112 step, a human model Hₘ(α) as a function of shape parameters a may be obtained by sampling a given shape space.

In the mobilizing 113 step, the human model may be subjected to methods of classical animation approaches. Motion capture sequences may be manually acquired according to the needs using arbitrary motion capture technology to build a database J of relevant motions. Every sequence j^{MOCAP} comprises a time series of joint locations and rotations jₖ^{M} (the superscript M does not refer to the surface mesh, but refers to “Motion Capture”):

j^{MOCAP}={j₁^{M}, j₂^{M}, j₃^{M}, . . . , j_{K}^{M}}

Mobilizing 113 the 3D body model may comprise: retargeting 1131 the given motion capture data onto the body skeleton model of the 3D body model; and skinning 1132 the body surface mesh model of the retargeted 3D body model in accordance with a Linear Blend Skinning (LBS) algorithm and given mobilization weights.

In the retargeting 1131 step, the motion capture data is thus retargeted onto the target skeleton S from the body model m. For every joint location and rotation J r of the motion capture sequence, a corresponding jₖ^{T} is determined to yield a motion capture sequence in the space of human body models:

j^{TARGET}={j₁^{T},j₂^{T},j₃^{T}, . . . ,j_{K}^{T}}

Each jₖ^{T} corresponds to a certain pose of the same subject in the sequence. Consequently, in the skinning 1132 step, for every pose the vertex coordinates vₖ^{T} of the mesh have to be recalculated. This is achieved with LBS, according to which each vertex l at time step k with position vₖ^{T} belongs to one or more bones.

The influence of bone Bᵢ onto vertex l is controlled by weights w_{l,i}, such that the position V_{k,l}^{T} is obtained as:

v_{k,l}^{T}=Σᵢw_{l,i}A_{k,i}v_{0,l}^{T} ∀k∈{1, . . . ,K},l∈{1, . . . ,|V|}

where the A_{k,i} denotes the transformation that bone Bᵢ undergoes in time step k, relative to a reference pose, defined through j₀^{T} and corresponding mesh coordinates v₀ₗ^{T}. In summary, from the skinning 1132 step, a set of vertex coordinates for each time step k is obtained, resulting in a time series of vertex coordinates:

v^{TARGET}={v₁^{T},v₂^{T},v₃^{T}, . . . ,v_{K}^{T}}

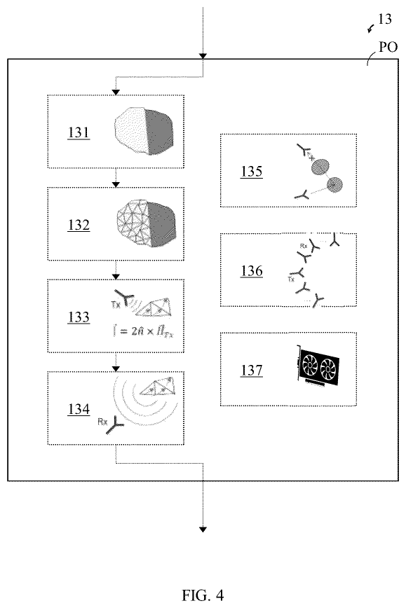

FIG. 4 deals with details of the EM simulation that may form part of the generating 13 step.

An EM simulation can correctly predict the propagation of electromagnetic signals and its interaction with an arbitrary imaging target by solving the underlying Maxwell's equations. An exact solution of these equations by so-called exact techniques, such as finite element methods or solving integral equations, for typical personnel security screening scenarios is computationally expensive. To reduce the computational effort for electrically large geometries, high-frequency approximation techniques have been developed. In this domain, two very popular techniques are available: raytracing approaches like shooting-and-bouncing-waves (SBR) and physical optics (PO) based approaches. Herein, PO based simulation is used to produce sufficiently realistic results within reasonable time frame, whereas raytracing approaches appear to lack sufficient accuracy. Besides, EM simulation could also be done by directly estimating the RF image based on the knowledge of the point spread function (PSF) of the imaging system, which describes an impulse response of a focused optical imaging system to a point source or point object.

The imaging transformation may thus comprise a physical optics based EM simulation.

Accordingly, the generating 13 step may include: dividing 131 a scattering object into two parts; defining 132 a simulation mesh; calculating 133 currents on all triangles; and calculating 134 a filed radiated by the currents.

However, the generating 13 step may further have to deal with a number of complications as well: For example, the physical optics based simulation may comprise ray-based shadowing 135. For example, the physical optics based simulation may take into account multiple transmitters and receivers 136. For example, the physical optics based simulation may use graphics processing unit (GPU) acceleration 137. As an alternative to the PO-based EM simulation, the imaging transformation may comprise an inference by a machine learning, ML, algorithm being trained for RF imaging of 3D body samples. For example, an artificial neural network may be trained to efficiently compute the at least one synthetic RF image without any underlying physical understanding that falls within the meaning of a “simulation”.

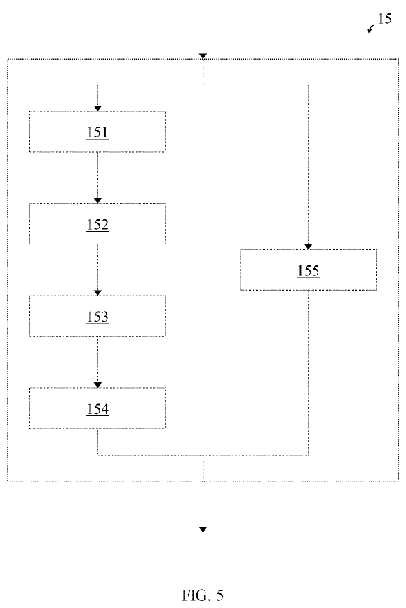

FIG. 5 deals with superpositioning a threat object to be detected into the body model or the microwave images.

When superimposing the threat object into the body model, providing 15 the RF image to be analyzed may comprise: augmenting 151 the shaped 3D body model with a CAD-based 3D model of an object to be detected; mobilizing 152 the augmented 3D body model in accordance with the given motion capture data; sampling 153 the mobilized augmented 3D body model; and generating 154 the RF image to be analyzed in accordance with the EM simulation of the augmented 3D body sample.

By contrast, when superimposing the threat object directly into the RF image, providing 15 the RF image to be analyzed may comprise: generating 155 the RF image to be analyzed in accordance with an RF image of an object to be detected (i.e., take the object, put it inside the full-body scanner, and make snapshots from all relevant angles) and one of the at least one synthetic RF images corresponding in terms of the shooting angle, the body constitution and/or the body posture. In other words, the synthetic RF image of the human body and the corresponding RF image of the object may be fused.

Either way enables a training of the ML algorithm for new unseen objects without a huge data collection.

1. A process for generating at least one synthetic radio frequency, RF, image for machine learning, the process comprising
having a three-dimensional, 3D, body model of a human;
sampling the 3D body model; and
generating the at least one synthetic RF image in accordance with an imaging transformation of the 3D body sample.

2. The process of claim 1,
the at least one synthetic RF image comprising a microwave image.

3. The process of claim 1,
the at least one synthetic RF image comprising a plurality of synthetic RF images.

4. The process of claim 3,
the plurality of synthetic RF images representing different shooting angles.

5. The process of claim 3,
the plurality of synthetic RF images representing different body constitutions.

6. The process of claim 3,
the plurality of synthetic RF images representing different body postures.

7. The process of claim 3,
the plurality of synthetic RF images representing different body movements.

8. The process of claim 1, wherein having the 3D body model comprises
forming a 3D body model from a computer-aided design, CAD, based body skeleton model and a CAD-based body surface mesh model;
shaping the 3D body model in accordance with given shape parameters; and
mobilizing the 3D body model in accordance with given motion capture data.

9. The process of claim 8, wherein mobilizing the 3D body model comprises
retargeting the given motion capture data onto the body skeleton model of the 3D body model; and
skinning the body surface mesh model of the retargeted 3D body model in accordance with a Linear Blend Skinning, LBS, algorithm and given mobilization weights.

10. The process of claim 1,
the imaging transformation comprising one of:
a physical optics based electromagnetic, EM, simulation, and
an inference by a machine learning, ML, algorithm being trained for RF imaging of 3D body samples.

11. The process of claim 10,
the physical optics based simulation comprising ray-based shadowing.

12. The process of claim 10,
the physical optics based simulation taking into account multiple transmitters and receivers.

13. The process of claim 10,
the physical optics based simulation using graphics processing unit, GPU, acceleration.

14. The process of claim 1, further comprising
training a further ML algorithm in accordance with the at least one synthetic RF image for inference of a similarity with the at least one synthetic RF image.

15. The process of claim 14, further comprising
providing an RF image to be analyzed.

16. The process of claim 15, wherein providing the RF image to be analyzed comprises
augmenting the shaped 3D body model with a CAD-based 3D model of an object to be detected;
mobilizing the augmented 3D body model in accordance with the given motion capture data;
sampling the mobilized augmented 3D body model; and
generating the RF image to be analyzed in accordance with the EM simulation of the augmented 3D body sample.

17. The process of claim 15, wherein providing the RF image to be analyzed comprises
generating the RF image to be analyzed in accordance with an RF image of an object to be detected and one of the at least one synthetic RF images corresponding in terms of the shooting angle, the body constitution and/or the body posture.

18. The process of claim 15, further comprising
inferring from the trained ML algorithm the similarity of the provided RF image to be analyzed with the at least one synthetic RF image.

19. The process of claim 15, further comprising
inferring from the trained ML algorithm the similarity with the provided RF image to be analyzed with the at least one synthetic RF image for different simulation setups of the physical optics based simulation; and
deriving a robustness of the inference against the different simulation setups.

20. A device for generating at least one synthetic radio frequency, RF, image for machine learning, the device comprising
a processor, being configured to
have a three-dimensional, 3D, body model of a human;
sample the 3D body model; and
generate the at least one synthetic RF image in accordance with an imaging transformation of the 3D body sample.
